(19) United States
(12) Patent Application Publication
(10) Pub. No.: US 2026/0071849 A1
(43) Pub. Date: Mar. 12, 2026

(54) ENERGY DISSIPATION PLATE FOR ARMOR COMPRISING A FIBROUS POROUS DAMPING MATERIAL

(71) Applicant: SAINT-GOBAIN CENTRE DE RECHERCHES ET D’ETUDES EUROPEEN, COURBEVOIE (FR)

(72) Inventors: Alexane MARGOSSIAN, CAVAILLON CEDEX (FR); Christian HIS, CAVAILLON CEDEX (FR); Coralie TEULERE, AUBERVILLIERS (FR); Jonas BOUCHARD, COURBEVOIE (FR)

(21) Appl. No.: 19/108,306

(22) PCT Filed: Aug. 24, 2023
(86) PCT No.: PCT/EP2023/073287

§ 371 Date: Mar. 3, 2025

(30) Foreign Application Priority Data
Sep. 2, 2022 (FR) 2208777

(51) Int. Cl. F41H 5/04; C08J 5/04; C08J 5/24; F41H 5/013

(52) U.S. Cl. CPC F41H 5/0435; C08J 5/0405; C08J 5/048; C08J 5/241; F41H 5/013; C08J 2300/24

(57) ABSTRACT

An impact energy dissipation plate for anti-ballistic armor, the dissipation plate including a damping material including a fibrous reinforcement bonded by an organic matrix including a thermosetting resin, the reinforcement including inorganic fibers assembled in the form of yarns, the damping material having the following features the volume fraction of fibrous reinforcement of the damping material is between 20% and 70%, the remainder to 100% including the matrix and porosity; the fibrous reinforcement includes at least 50% by volume of silica fiber yarns of which SiO₂ content by mass of more than 90%, and the porosity of the damping material is between 2% and 10% by volume.

The invention relates to an anti-ballistic protective device, in particular a personal protective device (e.g., bullet-proof vest), a protective device for a vehicle (land, sea or air) or a stationary installation (e.g., building, perimeter wall, guard post), or detection or communication equipment, e.g., a radome.

The invention relates more particularly to an energy dissipation plate for armor, comprising a damping material, including the material itself. In particular, such a plate can stop a bullet or projectile fired from a weapon, particularly a firearm.

The invention further relates to an armor plate comprising said energy dissipation plate and an anti-impact plate, made of a hard material, placed in front of said dissipation plate with respect to the direction of the threat or projectile. This type of design is particularly suitable for reinforcing protection when the projectile is highly penetrating.

Among anti-ballistic protection materials, Dyneema® HB26, for example, is known from US2013220106A1, and is a composite comprising several layers of mono-oriented ultra-high molecular weight polyethylene (UHMWPE) fibers, said layers being arranged perpendicularly from one layer to the next in a polyurethane matrix. This material would be used to protect against ammunition used by assault rifles such as the AK47, or the impact of improvised bombs by distributing impact energy.

To reduce the mass of protective devices without impeding anti-ballistic performance, many materials have been proposed to constitute personal armor, for which the ratio of armor mass to protective surface must remain low, typically less than 50 kg/m2, or non-personal armor for vehicles or stationary installations, for which the ratio of mass to protective surface is typically higher than 20 kg/m2. Among the ceramic materials used in particular in such an application are metal carbide-based products. For example, WO 2013/186453 A1 describes a silicon carbide (SiC) product with a specified grain shape and chemical composition to form an impact armor or armor element. EP1710218A1 discloses a sintered material based on silicon nitride and tungsten carbide with the help of additives such as rare earths, tungsten added preferably in oxidized form.

WO2008/130451 (EP2095055A1) has also proposed an approach consisting of reducing the propagation of the stress wave related to the impact of the projectile by using a shell formed this time by a permeable medium, typically a layer of organic fibers (e.g., aramid) fixed on the ceramic part and then impregnated by a hyperelastic polymer in order to absorb the energy related to the impact of the projectile and to reduce the propagation of cracks and the multifracturing of the ceramic material.

However, there is an ongoing need to improve anti-ballistic protection devices, as measured in particular by their ballistic performance relative to their mass, in particular so that they can resist dynamic deformation due to ballistic impact without any increase in their mass, or even while reducing it, in particular to improve comfort in the case of personal protection or to reduce energy consumption in the case of vehicle protection.

The object of the present invention is therefore to offer an anti-ballistic armor plate with improved performance, in particular improved resistance to dynamic deformation, for the same surface density. Such an improvement results in particular from the use of the plate made of the damping material according to the invention, as described below.

According to a first general aspect, the present invention relates to an impact energy dissipation plate for anti-ballistic armor, said dissipation plate consisting of a damping material consisting of a fibrous reinforcement bonded by an organic matrix, said reinforcement comprising inorganic fibers, assembled in the form of yarns, preferably long yarns, said matrix comprising a thermosetting resin coating said yarns, said damping material having the following features:
the volume fraction of fibrous reinforcement of said damping material is between 20% and 70%, the remainder to 100% consisting of said matrix and the porosity of said material;
said fibrous reinforcement comprises at least 50% by volume of silica fiber yarns of which the SiO₂ content by weight is greater than 90%,
the porosity of said damping material is between 2% and 10% by volume.

The inventors have discovered that such a damping material, in the form of a controlled-porosity composite comprising an organic matrix encapsulating a reinforcement comprising yarns with a high silica content, offers improved resistance to dynamic deformation, at the same surface density, compared with materials of the prior art.

In particular, an armor plate provided with such a damping material shows a shallower deformation depth and a larger lateral deformation surface, which, at equivalent mass, translates into a greater ability to absorb energy due to the impact of, for example, a projectile fired by a firearm.

Various preferred embodiments according to the present invention are described below, which can of course be combined with each other as appropriate:
the bulk density of the damping material is greater than 1.0 g/cm³, preferably greater than 1.5 g/cm³ and/or less than 2.0 g/cm³, preferably less than 1.8 g/cm³;
the volume fraction of fibrous reinforcement of said damping material is between 30 and 50%, the remainder consisting of porosity and matrix.
the fibrous reinforcement comprises at least 70% by volume of silica fiber yarns, preferably at least 80%, more preferably more than 90% silica fiber yarns, preferably consisting substantially of silica fiber yarns, hereinafter referred to as silica yarns for the sake of simplicity;
the volume complement of at least 50% of said silica yarns of the fibrous reinforcement is represented by washed glass fibers.
the SiO₂ mass content of said silica yarns is greater than 95%, preferably greater than 97%, more preferably at least 99%;
the average equivalent diameter of said yarns is between 3 and 3000 micrometers, preferably greater than 8 micrometers and/or less than 1000 micrometers, preferably less than 500 micrometers;
the yarns are preferably single yarns;
the linear density of said yarns is greater than or equal to 500 tex, preferably less than 5000 tex;
the average equivalent diameter of the silica fibers making up the yarns is greater than or equal to 3 micrometers, preferably greater than or equal to 5 micrometers, even more preferably greater than or equal to 7 micrometers
the average equivalent diameter of said fibers is less than or equal to 20 micrometers;
the reinforcement consists substantially of said silica yarns or even consists of said silica yarns;
the yarn twist level is on average less than or equal to Z20, preferably less than or equal to Z10, more preferably less than or equal to Z3;
said fibrous reinforcement is in the form of at least one ply or layer of a textile, preferably a woven fabric, consisting of a network of parallel warp yarns, with preferably weft yarns running transversely, preferably perpendicularly, through said network. In one possible embodiment, the reinforcement consists of several superimposed layers of fabric, each layer being impregnated with resin to form the damping material. Preferably, the superimposed fabric layers have the same pattern or weave. This has the advantage of avoiding the phenomenon of interpenetration or interlacing of the yarns of one layer with those of a lower or upper layer directly in contact;
the grammage of a textile layer or fabric ply is greater than or equal to 350 g/m2, preferably less than 2000 g/m², more preferably less than 1000 g/m², most preferably less than 700 g/m². Lower grammage means more layers of fabric, making the manufacturing method longer and therefore more costly. Excessive grammage leads to poorer performance for equivalent weight per unit area.
the porosity of said damping material is less than or equal to 5% by volume;
said matrix has pores with an average width of between 10% and 500% of the average equivalent diameter of said fibers, preferably between 10% and 100% of said diameter, more preferably between 10% and 50% of said diameter. Preferably, in number, more than 90%, preferably more than 95%, more preferably more than 99% of the pores have a width greater than 1 micrometer, preferably greater than 2 micrometers, more preferably greater than 5 micrometers and/or less than 50 micrometers, preferably less than 30 micrometers, more preferably less than 15 micrometers;
said matrix optionally comprises additives such as a mineral filler;
the density of said resin is between 0.8 and 1.35 g/cm³;
the resin substantially comprises the chemical elements carbon (C), hydrogen (H), and oxygen (O);
the matrix comprises an epoxy resin;
the damping material has a Vickers hardness of less than 3 GPa;
said dissipation plate has a surface area greater than or equal to 150 cm² and/or a thickness of between 1 and 50 mm, preferably between 3 and 20 mm;
said dissipation plate is surrounded by an envelope of containment material,
said anti-ballistic armor plate comprises said impact energy dissipation plate.

In particular, in some embodiments of the present invention, an anti-impact plate can be placed in front of the plate for absorbing or dissipating impact energy in order to resist high-penetration projectiles, for example to comply with NIJ-IIIA, NIJ-III or NIJ-IV standards for personal protection or STANAG 4569 for non-personal protection.

According to a second general aspect, the present invention thus relates to an armor plate as previously described, further comprising an anti-impact plate made of a material with a hardness greater than that of the damping material. Said anti-impact plate is generally thicker than 2 mm, and is placed in front of said dissipation plate, with respect to the direction of impact.

Further preferred embodiments of the present invention, which can of course be combined with one another where appropriate, are described below, describing the case of an armor plate comprising an anti-impact plate in addition to the damping plate described above:
the thickness of said anti-impact plate is greater than 4 mm, preferably 6 mm, more preferably greater than 10 mm. According to one possible embodiment, the thickness of said plate is less than 100 mm, preferably less than 50 mm, or even less than 20 mm;
the ratio of the thickness of the energy dissipation plate to the thickness of the anti-impact plate is preferably between 0.5 and 5, preferably greater than 1 and/or less than 3;
the surface area of said anti-impact plate is greater than 150 cm²;
the surface area of the energy dissipation plate is at least 80% of that of the anti-impact plate;
the material of the anti-impact plate has a Vickers hardness greater than 3 GPa, preferably greater than 5 GPa, more preferably greater than 10 GPa;
the bulk density of the anti-impact plate is less than 10 g/cm³, preferably less than 7 g/cm³, more preferably less than 5 g/cm³, more preferably less than 3.2 g/cm³, more preferably less than 3.0 g/cm³ and/or greater than 1.0 g/cm³;
the material of the anti-impact plate is a sintered material comprising grains, preferably consisting of a metal carbide or metal boride. More preferably, the grains are silicon carbide or boron carbide grains or a mixture of these two carbides;
According to one possible embodiment, the grains are only silicon carbide grains, with possibly a metallic phase, preferably comprising the element silicon;
According to one possible embodiment, the grains of said sintered material are bonded by a matrix, comprising or consisting of a silicon nitride phase (Si₃N₄) and/or a silicon oxynitride phase (Si₂ON₂) and/or SiAlON;
According to one possible embodiment, said grains of said sintered material are bound by a matrix which preferably represents between 5 and 40% by mass, preferably between 15 and 35% by mass, of the mass of the material of the anti-impact plate;
said anti-impact plate is bonded to said energy dissipation plate by means of an adhesive selected from adhesives based, for example, on polyurethane, epoxy polymers or thermoplastic polymers or elastomers;
said armor plate is surrounded by an envelope of containment material.

According to a third general aspect, the armor plate according to the invention, comprising said impact energy dissipation plate, is covered at least partially, preferably completely, with an outer envelope made of a containment material, for example in the form of a textile, for example a fabric, comprising glass fibers, or carbon fibers, or polyethylene PE, in particular ultra-high-density polyethylene (UHMPE), or aramid, in particular Kevlar®, or metal such as aluminum or even steel, particularly in the case of non-personal protection.

The present invention also relates to a method for manufacturing said damping material or a dissipation plate comprising said material as previously described, said method comprising the following steps:
1) preparing, preferably by weaving, at least one fibrous layer comprising yarns of silica fibers with a mass content greater than 90% SiO₂ so as to obtain a reinforcement comprising at least 50% by volume of said yarns;
2) preparing a mixture comprising a thermosetting resin of which the viscosity, measured using a 20 mm-diameter plate/plate rheometer with 1 mm air gap is between 80 and 300 Pa·s for a shear rate of 100 to 200 s⁻¹ at 50° C.;
3) impregnating each fibrous layer with said mixture, and stacking each layer so as to obtain a preform wherein the volume fraction of fibrous reinforcement of said damping material is between 20% and 70%;
4) curing the preform in an autoclave at controlled pressure and temperature to polymerize and crosslink said resin and form a reinforcement bonded by an organic matrix constituting said damping material.
5) optionally, shaping the resulting damping material into a plate, in particular by cutting or deburring.

Various preferred embodiments according to the present invention are described below, which can of course be combined with each other as appropriate:
the organic matrix resin is a thermosetting resin chosen from phenolic resins; epoxy resins; polyimide resins; polyurethane; or derivatives thereof, or a mixture of these products. -resin additives are selected from: a catalyst, a reinforcing agent, a release agent and a hardener.
the resin mixture represents at least 30%, preferably more than 35%, more preferably 40% and less than 70%, preferably less than 60%, more preferably less than 55%, by mass based on said mixture from step 2).
the resin is preferably an epoxy resin. The epoxy equivalent weight of said resin measured according to ASTM D1652 is greater than 200, preferably greater than 220. This is the mass in grams of resin required to provide one mole of epoxy group. A lower weight results in a resin with a higher bonding surface to the silica yarns of the fibrous reinforcement, while the dissipative material has a lower porosity.
the preform is preferably cured at less than 200° C. between 1 and 5 bars. Preferably, it comprises a first stage with a step between 8° and 120° C. and preferably a second stage with a step between 13° and 180° C.

The present invention also relates to the use of a dissipation plate or an armor plate as previously described as anti-ballistic protection:
of a person, said protection being selected from a bullet-proof vest, a helmet, or
of a land, sea or air vehicle, or
of a stationary installation chosen from a building, a perimeter wall or a guardhouse, or
of a radome, detection or communication equipment, especially optronics equipment.

Without departing from the scope of the invention, such a use can be implemented in the form of a plate, a tile, a mosaic, for example in the form of hexagons or nodules, a breastplate, a shield, a helmet, a door, a seat, or a tube.

The following indications and definitions are given in connection with the preceding description of the present invention:
A “fiber” is a structure oriented in one direction and made of the same material of which the length is greater than 5 times its equivalent diameter.
A “long fiber” is a fiber of which the length is greater than 1 mm and less than 10 mm.
A “continuous fiber” is a fiber of which the length exceeds 10 mm.
A yarn is made up of a plurality of fibers. A “long yarn” is a yarn made up of long fibers. A “continuous yarn” is a yarn made up of continuous fibers longer than 10 mm.
The equivalent diameter of a fiber or yarn is the diameter of a disk with the same surface area as the cross-section of said fiber or yarn at mid-length.
A “single yarn” is an assembly of fibers that, in cross-section, comprises more than 10 and preferably fewer than 500,000 fibers, and of which the length is greater than 5 times the diameter. The fibers are assembled in such a way as to be wound or not wound on themselves according to a twist level S or Z depending on the winding direction and of which the index from 0 to 30 corresponds to the number of turns per meter. A twist level Z₀ corresponds to a yarn of which the fibers are not wound and are arranged in parallel.
An “assembled yarn” is an assembly of single yarns which, in cross-section, preferably comprises more than 2 and more preferably less than 500 single yarns.
A parallel assembly of single yarns after warping in order to align them (or “staple yarn”) is also a secondary assembly.
A textile can be:
an organized structure of single or assembled yarns, in particular a knitted fabric, a braid, a canvas, a woven fabric, or
a random structure of single or assembled yarns, e.g., a canvas, and/or fibers not incorporated in the form of yarns, said random structure being e.g., paper or felt, a random structure not being preferred.
the weave of a fabric refers to the way in which the yarns cross each other, helping to define a particular pattern.

The equivalent diameter of a grain is defined as half the sum of the greatest length of the grain and the greatest width of the grain, measured in a direction perpendicular to said greatest length.

The maximum and average equivalent diameters of particles, fibers, or yarns are typically determined by observing the microstructure of the material, typically using SEM (scanning electron microscopy) images of a cross-section of said material.

The term “matrix” means a crystallized or non-crystallized phase providing a substantially continuous structure between the grains, or fibers or yarns in the case of a fibrous material, obtained from the constituents of the feedstock and possibly a heat treatment. A matrix substantially surrounds the grains, or fibers or yarns in the case of a fibrous material, i.e., coats them.

In an organic matrix composite such as the damping material according to the present invention, the fibrous reinforcement is bonded by a thermosetting resin matrix. It is obtained by impregnating a fibrous textile with a resin mixture comprising at least one or more prepolymers, a hardener and preferably a catalyst and a reinforcing agent, or even a release agent, followed by a curing or hardening heat treatment to polymerize and crosslink the resin to form a thermosetting resin matrix.

In a sintered ceramic body, such as the anti-impact plate, the ceramic grains are bonded by the matrix obtained by sintering a preform. During the sintering process, they substantially retain the same shape and chemical nature as in the starting charge. In the sintered ceramic body, the matrix and the grains together represent 100% of the mass of the product.

“Bulk density” within the meaning of the present invention, means the ratio equal to the mass of the product divided by the volume occupied by said product. It is conventionally determined by the Archimedes method. For example, the ISO 5017 standard specifies the conditions for such a measurement. This standard also makes it possible to measure the open porosity of a ceramic material.
the porosity of the damping material is measured in accordance with ASTM D3171-15.

In particular, the volume fraction of fibrous reinforcement T_{f} is the percentage ratio between the apparent volume of fibers and the apparent volume of the damping material. It is calculated using the following formula:

$$Tf = \frac{Vfibers}{Vcomp} = \frac{Mfibers \times dcomp}{Mcomp \times dfibers}$$

where:
V_{fibers} is the apparent volume of the fibers
M_{fibers} is the mass of fibers
d_{fibers} is the density of the fibers
V_{comp} is the apparent volume of the damping material
M_{comp} is the mass of the damping material
d_{comp} is the density of the damping material

The mass of the composite can be measured simply by weighing the damping material, the bulk density of said material being determined by hydrostatic weighing according to Archimedes' principle.

Fiber mass can be determined after resin combustion/digestion according to ASTM D3171-15. Then, by hydrostatic weighing, it is possible to determine the bulk density of said fibers.
The pore width of the damping material is measured by analyzing images taken with a scanning electron microscope.
The SiO₂ mass content of the reinforcement's silica yarns can be measured by X-ray fluorescence.
The phase composition of the material constituting the anti-impact plate is normally obtained by X-ray diffraction and Rietveld analysis. Elemental nitrogen (N) levels in sintered products were measured using LECO analyzers (LECO TC 436DR; LECO CS 300). Values are provided in mass percentages. The crystallized phases, especially the nitrogenous crystallized phases or residual metals can be determined by X-ray diffraction and quantified by the Rietveld method.
The Vickers hardness of a material can be measured with a standardized diamond pyramid tip with a square base and an apex angle between faces equal to 136°. The imprint made on the grain therefore has the shape of a square; the two diagonals d1 and d2 of this square are measured with an optical device. The hardness is calculated from the force applied to the diamond tip and the mean value d of d1 and d2 according to the following formula:

$${H}_{V} = 0.189 \cdot \frac{F}{{d}^{2}} with \begin{matrix}Hv = Vickers hardness \\ F = Applied force [ N ] \\ d = Mean of diagonals of the imprint [ mm ]\end{matrix}$$

The strength and duration of the application are also standardized. The applicable reference standard for ceramic materials in particular is ASTM C1327:03 “Standard Test Method for VICKERS Indentation Hardness of Advanced Ceramics”.
“Median diameter” or “median size” of a set of particles, in particular a powder, is called the D₅₀ percentile, that is, the size dividing the particles into first and second populations equal in volume, these first and second populations comprising only particles having a size greater than, or less than, respectively, the median size.
The term “residual” refers to a component present in the feedstock and still present in the sintered product obtained from this feedstock.
Impurities are understood to mean the inevitable constituents, unintentionally and necessarily introduced with the raw materials or resulting from the reactions with those constituents. The impurities are not necessary constituents but only tolerated.
“Containing a” or “comprising a” is understood to mean “comprising at least one”, unless otherwise specified.

Unless otherwise specified, all percentages in this description are mass percentages.

Unless otherwise stated, all averages are arithmetic means.

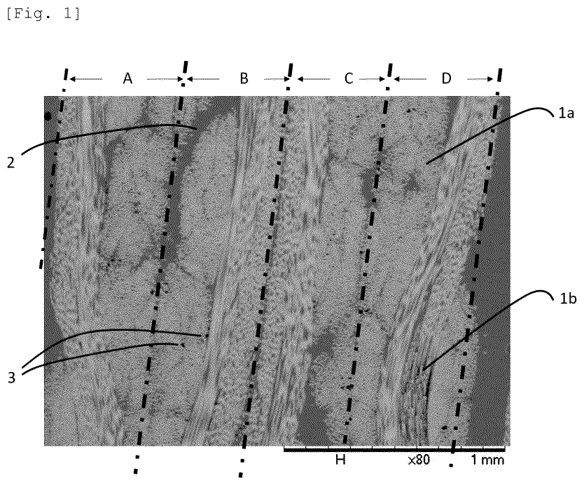

FIG. 1 shows a scanning electron microscope view of a cross-section of the damping material of Example 3 according to the invention, the reinforcement of which is made up of a plurality of plies or layers (A, B, C, D) of fabric. The fabric consists of silica fibers 1a and 1b assembled into single yarns. The silica fiber yarns are networked, with warp yarns (consisting of fibers 1a) and weft yarns (consisting of fibers 1b), substantially perpendicular to one another, as shown in FIG. 1. The yarns are coated with resin matrix 2. Porosity is present within the matrix and at the interface between the yarns in the form of pores 3 with an average width of around 3 micrometers.

Depending on the configurations chosen, the product according to the invention allows protection against different types of projectiles, for example a bullet, a shell, a mine or an element projected by the detonation of explosives, such as bolts, nails (or IED for Improvised Explosive Device) and is normally an armor element for vehicles or personal protection, stationary installations or communication equipment, usually in the form of modules such as plates.

Under the impact of a projectile, an armor plate is known to fragment in order to absorb the projectile's impact energy. When the latter has a high penetrating power, it is necessary to use an anti-impact plate, placed between the threat and an impact energy dissipation plate. The main role of the anti-impact plate is to break the core of any projectile that comes into contact with the armor plate. The role of the dissipation plate is to consume the kinetic energy due to the impact of the projectile by plastic deformation and to maintain a level of containment of the armor plate, advantageously optimized by a containment envelope.

In the context of the present invention, the applicant has developed a new damping material for an armor plate capable of withstanding, for example, a 0.30-0.6-APM2 type threat, the damping material having a mass-to-surface ratio typically less than 20 kg/m². The result is a reduction in the total weight of the armor, for the same level of protection.

The various stages of a method according to the invention are described in more detail below.

### Preparing the Fibrous Reinforcement

The fabrics chosen preferably have 2D or UD waves. These weaves offer the best ballistic performance. In particular, the satin weave pattern is the most preferred, as the fabric in this pattern has fewer intersections between warp and weft, which can constitute potential points of weakness in the reinforcement. Silica fiber fabrics Q600 to Q660 supplied by Saint-Gobain Quartz are preferred because they have grammages greater than 350 g/m².

### Resin Preparation

The resin mixture is chosen from a resin of which the behavior is preferably rheofluidifying. In other words, its viscosity decreases as the shear stress increases over a certain range. The following range is particularly suited to the implementation and production of the damping material according to the invention. Preferably, the resin exhibits the following rheological behavior, measured using a plate/plate rheometer with 20 mm diameter plates and 1 mm air gap, at 50° C.:

| Shear rate (s⁻¹) | Dynamic viscosity (Pa · s) |
|---|---|
| 100 | 100 to 300 |
| 200 | 80 to 150 |
| >400 and <500 | <80 |

In order to obtain the best processing conditions for the composite damping material, in particular optimum impregnation time, the resin preferably exhibits the following rheological behavior, measured using a plate/plate rheometer with 20 mm diameter plates and 1 mm air gap at 50° C. by oscillation for 3 h at a frequency of 2 Hz for a deformation of 0.1%. After 3 hours, the resin preferably exhibits a viscosity of less than 400 Pa·s. Preferably, the variation in viscosity between 1 h and 3 h is less than 10%, preferably less than 5%.

Impregnating the reinforcement and forming prepregs: When the reinforcement is made up of several layers of textile or several plies of fabric, the resin is generally too viscous at room temperature to be able to impregnate a plurality of layers already stacked, so it is preferable to pre-impregnate each layer of textile or ply of fabric before stacking them.

The resin mixture is first heated to a processing temperature from which point its viscosity is preferably below 400 Pa·s with a shear rate of 200 s⁻¹, preferably to a temperature of around 50° C. A film of the resin mixture is deposited on a Teflon tray heated to the above processing temperature. The reinforcing layer, preferably a fabric ply, is deposited on the tray and a second resin film is then deposited on the reinforcing layer. Light pressure is applied to the prepreg to help impregnate the fabric. The prepreg is then placed in a sealed bag, if necessary kept in the freezer before being used for the next step after thawing to promote separation with the Teflon tray.

This first step can be repeated as many times as there are reinforcement layers to be superimposed, in order to form a stack of layers when the reinforcement consists of a plurality of layers.

Preferably, the prepreg preform thus obtained is then placed in a vacuum bag, maintained at less than 1 bar prior to curing.

### Curing the Prepreg

The preform is then placed in an autoclave for temperature and pressure cycling.

During this curing step, the first temperature rise phase, with a fluidization stage between 5° and 150° C. and a pressure rise up to 2 bar, makes it easier to eliminate potential off-gassing and distribute the resin as evenly as possible. The subsequent rise in temperature above the cross-linking temperature of the thermosetting resin enables polymerization of the resin and formation of the matrix encapsulating the reinforcement. The choice of resin within the claimed viscosity range advantageously makes it possible to obtain a damping material according to the invention with a controlled pore volume. The choice of a resin with workability conditions such as those described above advantageously results in a damping material with a controlled pore width distribution.

### Anti-Impact Plate

The anti-impact plate of the armor plate according to the invention, if present, can be obtained in particular by a method comprising the following steps:
a) preparing a starting feedstock including:
   at least one powder of silicon carbide particles,
   a powder comprising silicon metal,
   optionally a powder of a solid-phase sintering additive,
b) shaping the starting feedstock into the form of a preform;
c) removal from the mold after setting or drying;
d) optionally, drying the preform, preferably until the residual moisture content is between 0 and 0.5% by weight,
e) firing and sintering of the preform in a nitrogen atmosphere, or in a non-oxidizing atmosphere if nitrogen is present in the feedstock, preferably at a temperature of between 130° and 1600° C., to obtain the sintered product constituting the anti-impact plate.

In such a method, a first initial silicon carbide powder is used, the median diameter of the particles of which is between 10 micrometers and 500 micrometers, and preferably is between 50 and 300 micrometers. In some advantageous embodiments, a second silicon carbide powder is used, with a median size at least half that of the first and preferably with an average diameter of between 1 and 5 micrometers.

In step b), the preform may be obtained by casting or pressing the feedstock or the mixture into a mold, with or without vibration.

During curing in step e), the nitrogen from the kiln reacts (“reactive sintering”) with some of the preform's constituents, in particular with silicon metal or even with aluminum metal if any is present on its own or in alloy form with silicon, and also with calcined alumina or an aluminum silicate such as clay if these additions are present, to form a matrix and thus bind the grains of the ceramic body.

In the anti-impact plate of the armor plate according to the invention, ceramic grains, preferably grains of silicon carbide and/or boron, can be bonded by a matrix comprising a SiAlON phase without the addition of rare-earth compounds and without resorting to a high sintering temperature, i.e., a temperature above 1650° C. In particular, curing a preform comprising aluminum metal alone or in the form of an alloy with silicon in a nitrogen atmosphere at 1300 to 1500° C. for a sufficiently long time (>4 hours) produces a sintered impact plate with a mass content of residual metallic Al and Si less than 1%.

The initial mixture may also comprise a fraction of an alumina powder with a median diameter of between 1 and 10 micrometers, serving as a sintering agent.

The anti-impact plate of the armor plate according to the invention is in particular obtained by a method as described above, preferably in the presence of a sintering additive chosen from carbon, boron, titanium, or zirconium carbides, or zirconium or titanium borides, alone or in a mixture.

In a particularly preferred embodiment, the product is obtained by a process as described above in which the sintering additive comprises or consists of boron carbide B₄C. Sintering additive, often more simply called “additive” in the present description, refers to a compound usually known to allow and/or accelerate the kinetics of the sintering reaction.

In one embodiment, the starting stock contains a binder and/or a lubricant and/or a surfactant. In one embodiment, the starting filler does not contain a binder.

Mixing is carried out in such a way as to obtain a good homogeneity of distribution of the various elements, it being possible for the mixing time to be adapted to achieve this result.

Preferably, the mixing of the initial reagents is carried out in a jar mill, the mixing time being more than 15 hours. A mixing time of 24 hours is well suited. When the mixture is obtained, it can be atomized or granulated, for example by freeze granulation, in order to obtain granules which will be shaped, for example by pressing, in order to get a ceramic preform. Other shaping techniques can be used, such as injection or slip casting. After shaping, the preform can be machined.

The preform is then sintered. Sintering takes place in a nitrogen atmosphere.

Preferably, the silicon carbide powder has an elemental oxygen content of less than 2%, preferably less than 1.6%, preferably less than 1.4%, preferably less than 1.2%, preferably less than 1%, or even less than 0.7%, or even less than 0.5%, or even less than 0.3% by weight. In one embodiment, the oxygen element content of the silicon carbide powder can be reduced before use by any technique known to those skilled in the art, such as acid washing, for example.

In one embodiment, the aluminum content of the feedstock is less than 1000 ppm, or even less than 500 ppm, or even less than 300 ppm, based on the weight of the feedstock.

The curing takes place in a controlled atmosphere, preferably under nitrogen to obtain the nitrided intergranular phase.

The following examples are for illustrative purposes only and do not limit the scope of the present invention in any of the aspects described.

### EXAMPLES

With the exception of example 1, where the damping material is a commercially available composite, each example was produced by stacking 18 to 19 layers of resin-impregnated fabric (in order to work at constant surface density), followed by heat treatment in an autoclave at 2 bars, with a step at 100° C., and then a cross-linking step with a 3-hour step at 160° C., to obtain two damping plates with a surface area of around 150×150 mm². The thickness was adapted so that the final armor plates of all the examples could be compared, with a surface density equal to 42±1.5 kg/m².

For all examples, each of the damping plates was bonded using Elantech 891-892 epoxy adhesive supplied by Elantas to a SiC ceramic plate with a hardness greater than 10 Gpa, measured in accordance with ASTM C1327:03 and measuring 100×100×10 mm³, to produce two final armor plates.

### Example 1 (Comparative)

In this example, the impact energy dissipation plate is an HB26 Dyneema® damping material marketed by DSM as cited in US2013/0220106A1.

### Example 2 (Comparative)

The damping material in the comparative example 2 is made from a fibrous reinforcement in the form of a 500 g/m² fabric made of Quartzel® yarns, each single yarn consisting of 20 silica fibers with a mass content of over 99% SiO₂ and an average equivalent diameter of 9 micrometers. The yarns, with a linear density of 667 tex and a twist coefficient of Z3, are woven into a regular 8-harness satin weave with an undercut of 3, with perpendicular interlacing.

The matrix in Example 2 was obtained from an epoxy resin mixture comprising, by mass:
73% a mixture of three different epoxy prepolymers (composed of at least 70% of a prepolymer based on bisphenol A diglicidyl ether) with an average epoxy equivalent weight of 180 grams,
3% hardener in the form of dicyandiamide micron powder,
18% a reinforcing agent in the form of a polyphenylene ether resin of the formula Poly(2,6-dimethyl-1,4-phenylene ether), and
6% a modified imidazole catalyst supplied by Curezol®.

The dynamic viscosity of the resin measured at 50° C. for a shear rate of 200 s⁻¹ under the conditions previously described is 50 Pa·s.

### Example 3 (Invention)

The matrix of Example 3 according to the invention differs from the previous formulation in that the epoxy prepolymer components have been modified to incorporate approximately 50% by weight of an epoxy prepolymer obtained from cashew nut shell oil. The new epoxy prepolymer is a blend of two resins with an average epoxy equivalent weight of 253 grams. The viscosity of the new mixture of the two epoxy resins, measured under the same conditions as above, is 100 Pa·s.

### Example 4 (Comparative)

Comparative example 4 differs from example 3 in that every 2nd warp and weft is replaced by a Lincore® linen fiber yarn with a linear density of 500 tex, the final reinforcement having a grammage of 500 g/m², 43% of the mass being represented by linen yarns and 57% by pure silica yarns.

### Example 5 (Comparative)

Comparative example 5 differs from Example 3 in that the proportion of matrix has been halved.

### Example 6 (Comparative)

Comparative example 6 differs from example 3 in that the resin has a viscosity greater than 300 Pa·s and less than 500 Pa·s at a shear rate of 200 s⁻¹ at 50° C., measured under the same conditions as above.

The ballistic properties of each final armor plate are gathered in table 1 below. The ballistic performance of the various armor plates was assessed using measurements of the dynamic deformations on the rear face, which correspond to the elastic deformations of the damping materials during impact. Each armor plate was tested on Sueur 40 plastiline blocks with shore A hardness ranging from 15 to 19 against single-impact shots fired at their center. The shots were fired on the SiC face of the various armor plates in stand-alone configuration. The tests were carried out with the 0.30-06 AP M2 threat fired at a nominal speed of 878±9 m/s from a distance of 15 meters. On each plastiline block, a caliper was used to measure the depth and diameter of the deformations left by the dissipation plate at impact. These indicators characterize the dynamic deformations of the damping plates caused by impact. An arithmetic mean was calculated for each example.

The presence of a perforation “P” in Table 1 indicates a significantly reduced ballistic performance associated with a lower damping capacity.

The results reported in Table 1 below show that:

Compared with the commercial material of comparative Example 1, the dissipation plates of Example 3 according to the invention have, at equivalent surface density, a deformation depth reduced by a third and a deformation diameter increased by 20%, showing a significantly higher ability to dissipate energy compared with the reference product on the market.

Example 3, in comparison with Examples 2 and 4, shows that the material of which the reinforcement and matrix have been selected according to the invention has a higher energy dissipation capacity.

Comparative example 5 shows that a reinforcement volume fraction in excess of 80% reduces ballistic performance.

Comparative example 6 shows that a damping material obtained with an excessively viscous resin results in an excessively high level of porosity and, consequently, reduced ballistic performance.

TABLE 1

| | | | | | |
|---|---|---|---|---|---|
| Example 1 | Example 2 | Example 3 | Comparative | Example 5 | Comparative |
| comparative | comparative | invention | example 4 | comparative | example 6 |

Mass distribution (%) of reinforcement and damping material matrix

| | | | | | | |
|---|---|---|---|---|---|---|
| Silica yarn | N.A | 57.6 | 52.6 | 28.7 | >80 | 67 |
| mass fraction | | | | | | |
| (%) | | | | | | |
| Flax fiber mass | | 0 | 0 | 21.7 | 0 | 0 |
| fraction (%) | | | | | | |
| Resin mass | | 42.4 | 47.4 | 49.6 | <20 | 33 |
| fraction | | | | | | |
| (matrix) (%) | | | | | | |
| Resin viscosity | | 50 | 100 | 100 | 100 | >300 and <500 |
| in Pa · s* (in %) | | | | | | |
| epoxy | | 180 | 253 | 253 | 253 | 350 |
| equivalent | | | | | | |
| weight (g/eq) | | | | | | |

Armor plate damping material characteristics

| | | | | | | |
|---|---|---|---|---|---|---|
| Mean | 14 | 8.5 | 9 | 10 | 9 | 9.5 |
| thickness (mm) | | | | | | |
| Volume | >80 | 40 | 36 | 38 | >75 | 50 |
| fraction of | | | | | | |
| fibrous | | | | | | |
| reinforcement | | | | | | |
| (%) | | | | | | |
| Volume | 0 | 100 | 100 | <30 | 100 | 100 |
| fraction of | | | | | | |
| silica fiber in | | | | | | |
| reinforcement | | | | | | |
| (%) | | | | | | |
| Porosity x of | <2 | <2 | 2 < x < 5 | 2 < x < 5 | >5 | 13 |
| damping | | | | | | |
| material (%) | | | | | | |
| BD of damping | 0.97 | 1.57 | 1.63 | 1.43 | >1.3 | 1.52 |
| material | | | | | | |
| (g/cm³) | | | | | | |
| Density of | 0.9-1.3 | 1.1 | 1.1 | 1.1 | 1.1 | 1.1 |
| matrix resin | | | | | | |
| (g/cm³) | | | | | | |
| Grammage of | N.M | 500 | 500 | 440 | 500 | 500 |
| reinforcement | | | | | | |
| (g/m²) | | | | | | |
| Linear mass of | N.M | 667 | 667 | 667/500 | 667 | 667 |
| reinforcement | | | | | | |
| yarns (tex) | | | | | | |
| Average | 17 | 9 | 9 | 9 | 9 | 9 |
| equivalent fiber | | | | | | |
| diameter (μm) | | | | | | |
| Mean pore | N.M | <3 | 3 | 3 | >5 | >5 |
| width (um) | | | | | | |
| Yarn twist level | Z0 | Z3 | Z3 | Z3 | Z3 | Z3 |
| (Z) | | | | | | |

Ballistic performance (dimensions in mm) at equal surface density

| | | | | | | |
|---|---|---|---|---|---|---|
| Average depth | 24 | P | 16 | P | P | P |
| of deformation | | | | | | |
| Average | 60 | P | 72 | P | P | P |
| deformation | | | | | | |
| diameter | | | | | | |

N.A = not applicable;
N.M = not measured;
P = penetration;
*at 50° C. and shear of 200 s⁻¹;
BD = bulk density;

Of course, the present invention is not limited to the embodiments described and shown, provided by way of examples. In particular, combinations of the various embodiments described are also within the scope of the invention.

1. An impact energy dissipation plate for anti-ballistic armor, said dissipation plate consisting of a damping material consisting of a fibrous reinforcement bonded by an organic matrix, said reinforcement comprising inorganic fibers assembled in the form of yarns, said matrix comprising a thermosetting resin, said damping material having the following features:
the volume fraction of fibrous reinforcement of said damping material is between 20% and 70%, the remainder to 100% consisting of said matrix and porosity;
the fibrous reinforcement comprises at least 50% by volume of silica fiber yarns of which SiO₂ content by mass is greater than 90%;
the porosity of said damping material is between 2% and 10% by volume.

2. The dissipation plate according to claim 1, wherein the bulk density of said damping material is greater than 1.0 g/cm³ and less than 2.0 g/cm³.

3. The dissipation plate according to claim 1, wherein the linear mass of said yarns is greater than or equal to 500 tex.

4. The dissipation plate according to claim 1, wherein the average equivalent diameter of the silica fibers constituting said yarns is greater than or equal to 3 micrometers and/or less than or equal to 20 micrometers;

5. The dissipation plate according to claim 1, wherein said fibrous reinforcement consists substantially of said silica yarns.

6. The dissipation plate according to claim 1, wherein the reinforcement is in the form of at least one layer of a textile.

7. The dissipation plate according to claim 6, wherein the grammage of said textile layer is greater than or equal to 350 g/m².

8. The dissipation plate according to claim 1, wherein said matrix has, between said resin and said yarns, pores with an average width of between 10 and 100% of the average equivalent diameter of said fibers.

9. The dissipation plate according to claim 1, wherein said matrix comprises an epoxy resin.

10. An anti-ballistic armor plate comprising an impact energy dissipation plate according to claim 1.

11. The armor plate according to claim 10, further comprising an anti-impact plate consisting of a material with a hardness greater than that of the damping material, said anti-impact plate having a thickness greater than 2 mm, said anti-impact plate being placed in front of said dissipation plate, with respect to the direction of impact.

12. The armor plate according to claim 11, wherein the material of the anti-impact plate has a Vickers hardness greater than 3 GPa.

13. The armor plate according to claim 11, wherein the bulk density of the anti-impact plate is less than 10 g/cm³.

14. The armor plate according to claim 10, wherein the material of the anti-impact plate is a sintered material comprising grains of silicon carbide or boron carbide or a mixture of these two carbides.

15. The armor plate according to claim 14, wherein the grains of said sintered material are bonded by a matrix comprising a phase of silicon nitride Si₃N₄ and/or Si₂ON₂ and/or SiAlON.

16. The armor plate according to claim 10, wherein said anti-impact plate is bonded to said energy dissipation plate by means of an adhesive selected from adhesives.

17. A method for manufacturing a damping material or dissipation plate according to claim 1, said method comprising the following steps:
1) preparing at least one fibrous layer comprising yarns of silica fibers with a mass content greater than 90% SiO₂ so as to obtain a reinforcement comprising at least 50% by volume of said yarns;
2) preparing a mixture comprising a thermosetting resin of which the viscosity, measured using a 20 mm-diameter plate/plate rheometer with 1 mm air gap, is between 80 and 300 Pa·s for a shear rate of 100 to 200 s⁻¹ at 50° C.;
3) impregnating each layer with said mixture, and stacking each layer so as to obtain a preform wherein the volume fraction of fibrous reinforcement of said damping material is between 20% and 70%;
4) curing the preform in an autoclave at controlled pressure and temperature to polymerize and crosslink said resin and form a reinforcement bonded by an organic matrix constituting said damping material.

18. A method comprising providing a dissipation plate according to claim 1 as antiballistic protection:
of a person, said protection being selected from a bullet-proof vest, a helmet, or
of a land, sea or air vehicle, or
of a stationary installation chosen from a building, a perimeter wall or a guardhouse, or
of a radome or of detection or communication equipment.

19. The dissipation plate according to claim 6, wherein the textile is a woven fabric, consisting of a network of parallel warp yarns.

20. The dissipation plate according to claim 19, wherein the woven fabric includes weft yarns running transversely through said network.
